(19) United States
(12) Patent Application Publication
(10) Pub. No.: US 2005/0128907 A1
(43) Pub. Date: Jun. 16, 2005

(54) PLL circuit and an optical disk apparatus thereof

(75) Inventor: Manabu Katsuki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 10/934,950

(22) Filed: Sep. 3, 2004

(30) Foreign Application Priority Data
Dec. 16, 2003 (JP) 2003-417433

(51) Int. Cl. G11B 5/09

(52) U.S. Cl. 369/47.28; 369/47.35; 369/59.21

(57) ABSTRACT

An optical disk unit includes a pick-up component to read information stored on an optical disk provided within the disk unit and generate a reproduction signal corresponding to the information that has been read, the optical disk having a synchronization pull-in pattern region and a data region; an equalization circuit to receive the reproduction signal from the pick-up component and output an equalized signal corresponding to the reproduction signal received from the pick-up component; and a phase lock loop (PLL) circuit for generating a reproduction clock signal that is synchronized to the reproduction signal. The PLL circuit includes a reproduction clock generator to generate a first reproduction clock signal; a phase comparator to detect a phase difference between the reproduction signal and the first reproduction clock signal and output a phase comparison signal and a phase error signal; a phase detection circuit to receive the phase comparison signal and generate a correction signal for correcting the phase difference.

### CROSS-REFERENCES TO RELATED APPLICATIONS

This application claims priority to Japanese Patent Application No. 2003-417433, filed on Dec. 16, 2003.

### BACKGROUND OF THE INVENTION

The invention relates to a phase lock loop (PLL) circuit and A disk apparatus using the same, for reproducing data from a disk where data is recorded.

A storage disk, such as an optical disk, is well known as an information record medium. When reproducing data recorded on an optical disk, a reproduction clock in sync with a reproduction signal is generated in a PLL circuit, and processing of the reproduction signal, such as discrimination, demodulation, and so forth, is executed by use of the reproduction clock, thereby restoring recorded information.

An optical disk is provided with a synchronization pull-in pattern for use in pull-in to implement stable restoration of the recorded information. When executing reproduction from such an optical disk, it has been common practice to implement the generation of a stable reproduction clock early on by increasing a loop gain of a feedback loop at a time of reproducing the synchronization pull-in pattern (during a synchronization process), and to reduce adverse effects of disturbance such as noises, and so forth, by decreasing the loop gain at a time of reproducing data after synchronization.

Recording density has recently been enhanced as progress toward larger capacity for an optical disk advances, and there has since been made a proposal whereby recorded data is restored with high precision by sampling a reproduction signal and using, for example, a digital signal processing such as PRML (Partial Response Maximum Likelihood) method, and so forth. Also, a PLL circuit suitable for such a purpose has been proposed (Japanese Unexamined Patent Publication No. 2000-285605).

### BRIEF SUMMARY OF THE INVENTION

The PLL circuit as disclosed in Japanese Unexamined Patent Publication No. 2000-285605 is a good method for supplementing a capture range in the case of digital signal processing; however, if a synchronization pull-in pattern is completed before final synchronization of a reproduction clock with a reproduction signal, there remains a phase error between the reproduction signal and the reproduction clock, so that if a loop gain is changed over in as-described state, a problem arises in that the reproduction clock will be out of sync with the reproduction signal. This problem is described hereinafter by taking a PLL circuit of an analog configuration, shown in FIG. 7, as an example.

FIG. 7 is a block diagram of the PLL circuit, reference numeral 80 denotes a phase comparator, 81 a phase system filter, 82 a frequency system filter, 83 an addition circuit, 84 an oscillation circuit (VCO), and 85 a gain control circuit.

The phase comparator 80 executes phase comparison between the reproduction signal and the reproduction clock, outputting an error signal corresponding to a phase difference (for example, a current corresponding to a phase error) to the phase system filter 81, and the frequency system filter 82. The phase system filter 81 generates a phase system error voltage obtained by amplifying a phase error amount by a predetermined gain, outputting the phase system error voltage to the addition circuit 83. Meanwhile, the frequency system filter 82 executes charging of a capacitor with the current corresponding to the phase error, and so forth, to thereby generate a frequency system error voltage obtained by integrating the phase error amounts with the predetermined gain, outputting the frequency system error voltage to the addition circuit 83.

The addition circuit 83 adds up the phase system error voltage and the frequency system error voltage, delivering the sum thereof, as an oscillation control voltage, to the oscillation circuit 84. The oscillation circuit 84 generates a clock at a frequency corresponding to the oscillation control voltage, delivered by an oscillator. As a result of operation described as above, the reproduction clock from the oscillation circuit 84 is controlled so as to reduce the phase error amount, and the reproduction clock synchronized in phase with the reproduction signal is generated.

Further, when a synchronization pull-in pattern is completed, the phase system filter 81 and the frequency system filter 82 are controlled by the gain control circuit 85 such that the respective gains thereof are lowered in order to prevent data from being affected due to disturbance such as noises, and so forth, at a time of reproducing the data.

Next, referring to FIG. 8, there is described a synchronization process of the PLL circuit. FIG. 8A is a schematic illustration showing transition of control voltage over time during the synchronization process, and a solid line indicates the oscillation control voltage while a dotted line indicates the frequency system error voltage. Accordingly, a differential between the solid line and the dotted line represents the phase system error voltage. First, in the case where the reproduction clock has a frequency deviation at a point in time of a lock start, which is a pull-in start, the phase error due to the frequency deviation is first detected, whereupon the phase system error voltage undergoes a change to thereby control the oscillation control voltage, and an oscillation frequency is caused to undergo a change, so that the frequency of the reproduction clock comes to be in sync with that of the reproduction signal.

Subsequently, as a result of integration of the phase errors, the frequency system error voltage undergoes gradual changes. At this point in time, the phase error decreases by an amount corresponding to a change in the frequency system error voltage such that the frequency of the reproduction clock does not come out of sync with that of the reproduction signal. That is, the reproduction signal and the reproduction clock come to be substantially at the same frequency, and subsequently, the phase error decreases to thereby lead to a synchronous phase relationship as desired, whereupon synchronization is completed, resulting in lock completion.

FIG. 8B shows a relationship between the reproduction signal and the reproduction clock in a state where the phase error still remains prior to the lock completion. FIG. 8B shows the case of a pattern in which the reproduction signal undergoes a change at a cycle unit of the reproduction clock, and a position indicated by a dotted line represents a synchronization position as desired, so that a time when the front edge of the reproduction clock comes in sync with the synchronization position is deemed to be the time of the lock completion.

Now, an assumption is made on a case where the synchronization pull-in pattern is completed prior to the lock completion. In such a case, the respective gains of the phase system filter 81 and the frequency system filter 82 are changed over in a state where the phase error still remains as shown in, for example, FIG. 8B. In this case, since the frequency system error voltage, which is the output of the frequency system filter 82, is generated by integrating the phase error amounts as previously described, no instantaneous change occurs thereto.

However, since the phase system error voltage, which is the output of the phase system filter 81, is generated by amplifying the phase error amount by the predetermined gain, the phase system error voltage undergoes an abrupt change in response to changeover of the gain. Accordingly, as the oscillation control voltage is generated by summing up the phase system error voltage and the frequency system error voltage, the oscillation control voltage undergoes an abrupt change in response to the changeover of the gain, resulting in the frequency deviation between the reproduction signal and the reproduction clock. Further, because the gain is set low in this case, a problem has arisen in that it becomes impossible to achieve reproduction pull-in depending on a frequency deviation amount, and subsequently, the reproduction signal cannot be in sync with the reproduction clock at the time of data reproduction, resulting in failure to reproduce data.

The problems described can be resolved by a PLL circuit for generating a reproduction clock in sync with a reproduction signal from an optical disk having a synchronization pull-in pattern region and a data region, comprising: reproduction clock generation means for generating the reproduction clock; phase difference detection means for detecting a phase difference between the reproduction signal and the reproduction clock; and correction signal generation mean for generating a correction signal for correcting the phase difference, wherein the reproduction clock generation means generates the reproduction clock on the basis of input signals including a signal indicating the phase difference, and the correction signal.

Further, the problems described can be resolved by a PLL circuit for generating a reproduction clock in sync with a reproduction signal of an optical disk, comprising:

sampling means for sampling the reproduction signal; reproduction clock generation means for generating the reproduction clock; phase comparison means for detecting a phase difference between respective sampled signals and the reproduction clock; a frequency system filter for executing integration processing of an output of the phase comparison means with a predetermined multiple; a phase system filter for amplifying the output of the phase comparison means by the predetermined multiple; phase error variation detection means for detecting a phase error variation amount from the output of the phase comparison means; first addition means for executing addition of an amount fed from the phase error variation detection means to an output of the frequency system filter; subtraction means for executing subtraction of the amount fed from the phase error variation detection means from the output of the phase system filter; second addition means for adding up an output of the first addition means, and an output of the subtraction means; and digital-to-analog conversion means for converting the output of the second addition means into an analog voltage, wherein the reproduction clock generation means control an oscillation frequency on the basis of the output of the digital-to-analog conversion means, and the phase error variation detection means feed the first addition means and the subtraction means with an equal value.

The PLL circuit as described above is capable of implementing phase synchronization in a short period of time and stable changeover of the gain, and when the same is applied to an optical disk apparatus, use can be made of digital signal processing such as the PRML method, and so forth, so that it is possible to provide the optical disk apparatus having higher reliability.

In one embodiment, an optical disk unit includes a pick-up component to read information stored on an optical disk provided within the disk unit and generate a reproduction signal corresponding to the information that has been read, the optical disk having a synchronization pull-in pattern region and a data region; an equalization circuit to receive the reproduction signal from the pick-up component and output an equalized signal corresponding to the reproduction signal received from the pick-up component; and a phase lock loop (PLL) circuit for generating a reproduction clock signal that is synchronized to the reproduction signal. The PLL circuit includes a reproduction clock generator to generate a first reproduction clock signal; a phase comparator to detect a phase difference between the reproduction signal and the first reproduction clock signal and output a phase comparison signal and a phase error signal; a phase detection circuit to receive the phase comparison signal and generate a correction signal for correcting the phase difference.

In another embodiment, a phase lock loop (PLL) circuit for generating a reproduction clock signal that is synchronized to the reproduction signal derived from a storage disk having a synchronization pull-in pattern region and a data region includes a reproduction clock generator to generate a first reproduction clock signal; a phase comparator to detect a phase difference between the reproduction signal and the first reproduction clock signal and output a phase comparison signal and a phase error signal; a phase detection circuit to receive the phase comparison signal and generate a correction signal for correcting the phase difference; a phase filter to receive the phase error signal and output a phase error control signal; a frequency system filter to receive the phase error signal from the phase comparator and output a frequency error control signal; and a subtraction circuit to receive the phase error control signal from the phase system filter and the correction signal from the phase detection circuit and output a phase system control signal, the phase system control signal being obtained as a result of performing a subtraction according to the correction signal.

In yet another embodiment, an optical disk unit includes pick-up means for reading information stored on an optical disk provided within the disk unit and generating a reproduction signal corresponding to the information that has been read, the optical disk having a synchronization pull-in pattern region and a data region; equalization means for receiving the reproduction signal from the pick-up means and outputting an equalized signal corresponding to the reproduction signal received from the pick-up means; and means for generating a reproduction clock signal that is synchronized to the reproduction signal. The means for generating the reproduction clock signal includes means for generating a first reproduction clock signal; means for detecting a phase difference between the reproduction signal and the first reproduction clock signal; means for outputting a phase comparison signal and a phase error signal; means for receiving the phase comparison signal; and means for generating a correction signal for correcting the phase difference.

In yet another embodiment, a method for operating an optical disk unit includes reading information stored on an optical disk provided within the disk unit using a pick-up component, the optical disk having a synchronization pull-in pattern region and a data region; generating a reproduction signal corresponding to the information that has been read by the pick-up component; outputting an equalized signal corresponding to the reproduction signal received from the pick-up component; and generating a reproduction clock signal that is synchronized to the reproduction signal using a phase lock loop (PLL) circuit, wherein the PLL circuit generates a first reproduction clock signal, detects a phase difference between the reproduction signal and the first reproduction clock signal, outputs a phase comparison signal and a phase error signal, receives the phase comparison signal, and generates a correction signal for correcting the phase difference using the phase comparison signal.

In yet another embodiment, a phase lock loop (PLL) circuit for generating a reproduction clock signal that is synchronized to a reproduction signal obtained by reading an optical disk is disclosed. The PLL circuit comprises sampling means for sampling the reproduction signal obtained by reading the optical disk; reproduction clock generation means for generating the reproduction clock; phase comparison means for detecting a phase difference between respective sampled signals and the reproduction clock; a frequency system filter for executing integration processing of an output of the phase comparison means with a predetermined multiple; a phase system filter for amplifying the output of the phase comparison means by the predetermined multiple; phase error variation detection means for detecting a phase error variation amount from the output of the phase comparison means; first addition means for adding an amount received from the phase error variation detection means to an output of the frequency system filter; subtraction means for subtracting the amount received from the phase error variation detection means from the output of the phase system filter; second addition means for adding an output of the first addition means and an output of the subtraction means; and digital-to-analog conversion means for converting the output of the second addition means into an analog voltage, wherein the reproduction clock generation means controls an oscillation frequency on the basis of the output of the digital-to-analog conversion means, and the phase error variation detection means sends an equal value to the first addition means and the subtraction means

### BRIEF DESCRIPTION OF THE DRAWINGS

FIG. 1 is a block diagram of one embodiment of an optical disk apparatus according to the invention;

FIG. 2 is a block diagram of one embodiment of the PLL circuit according to the invention;

FIG. 3 is a block diagram showing a configuration of a digital frequency system filter by way of example;

FIG. 4 is a block diagram showing a configuration of a digital phase error variation detection circuit by way of example;

FIG. 5 is a schematic illustration showing a state of transition of respective control levels over time;

FIG. 6 is a flowchart of operations;

FIG. 7 is a block diagram of a conventional PLL circuit;

FIG. 8A is a schematic illustration showing transition of control voltage over time in the case of the conventional PLL circuit; and

FIG. 8B is a schematic illustration showing a relationship between a reproduction signal and a reproduction clock in the case of the conventional PLL circuit.

### DETAILED DESCRIPTION OF THE INVENTION

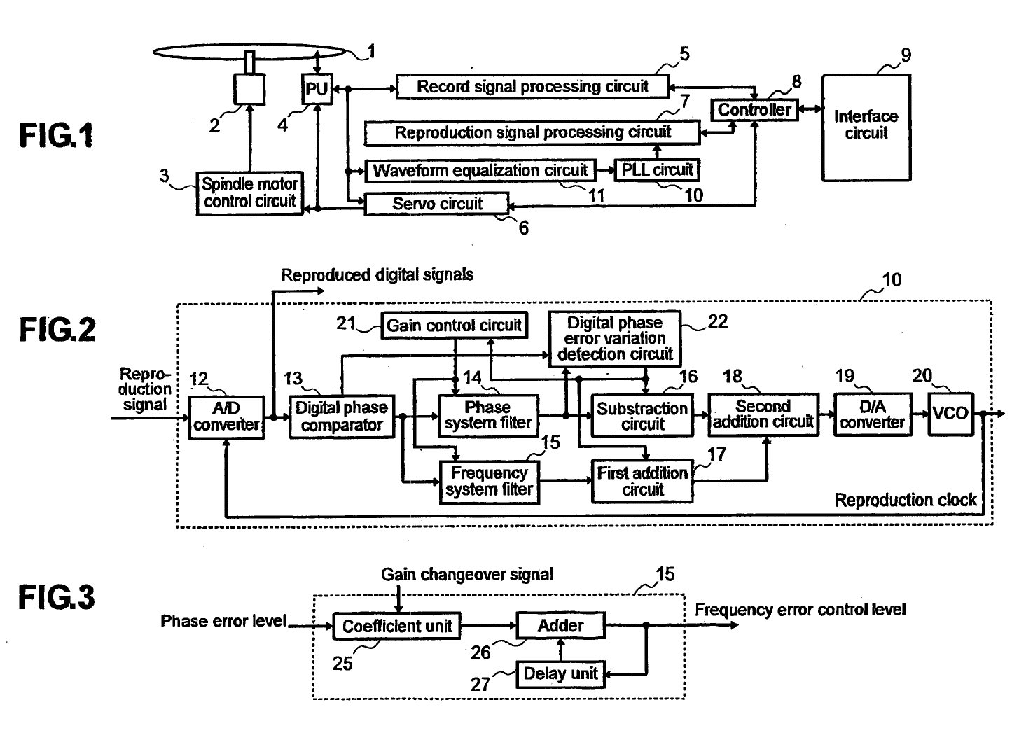

FIG. 1 is a block diagram showing one embodiment of storage disk apparatus, e.g., an optical disk apparatus, according to the invention. In FIG. 1, reference numeral 1 denotes a storage disk (or optical disk) capable of recording, 2 a spindle motor, 3 a spindle motor control circuit for controlling a spindle motor rotational speed, 4 a pickup (or an optical pickup), 5 a record signal processing circuit, 6 a servo circuit, 7 a reproduction signal processing circuit, 8 a controller, 9 an interface circuit, 10 a PLL circuit, and 11 a waveform equalization circuit.

A reproduction operation according the invention is described by way of example hereinafter with reference to FIG. 1. First, the controller 8 receives a reproduction instruction from outside via the interface circuit 9. Based on the reproduction instruction, the optical pickup 4 irradiates the optical disk 1 with laser beam of reproduction power at this point in time. Hereupon, the optical pickup 4 detects reflected light from the optical disk 1, delivering the reflected light as a reproduction signal to the waveform equalization circuit 11 and the servo circuit 6. The servo circuit 6 detects a disk rotational speed, and so forth, from the reproduction signal, delivering the disk rotational speed, and so fort to the spindle motor control circuit 3. The spindle motor control circuit 3 controls the spindle motor 2 such that the disk rotational speed is at a desired value. The servo circuit 6 detects an irradiation position of the reproduction laser beam of the optical pickup 4, on the optical disk 1, thereby controlling the position of the optical pickup 4 such that a desired position is irradiated with the laser beam by the optical pickup 4.

Meanwhile, the reproduction signal sent to the waveform equalization circuit 11 is adjusted in respect of a level, frequency characteristics, and so forth, and is subsequently delivered to the PLL circuit 10. The PLL circuit 10 generates a reproduction clock in sync with the reproduction signal, and at the same time, executes sampling of the reproduction signal with the reproduction clock to thereby send out digital reproduction signals along with the reproduction clock to the reproduction signal processing circuit 7. In the reproduction signal processing circuit 7, recorded data is restored with high precision by use of digital signal processing of the digital reproduction signals, such as the PRML method, and so forth, with the reproduction clock that is used as a reference processing unit, to be thereby sent out to outside via the interface circuit 9 according to an instruction from the controller 8.

FIG. 2 is a block diagram showing one embodiment of the PLL circuit according to the invention. In FIG. 2, reference numeral 12 denotes a sampling circuit (A/D converter) for sampling the reproduction signal, such as, for example, an analog-to-digital converter, 13 a digital phase comparator, 14 a digital phase system filter, 15 a digital frequency system filter, 16 a subtraction circuit, 17 a first addition circuit, 18 a second addition circuit, 19 a digital-to-analog conversion circuit, 20 a voltage controlled oscillator (VCO), 21 a gain control circuit, and 22 a digital phase error variation detection circuit. In the sampling circuit 12, the received reproduction signal is converted into the reproduction digital signals at multi-values for every reproduction clock to be thereby sent out to the digital phase comparator 13.

In the digital phase comparator 13, timing for executing phase comparison is generated on the basis of, for example, detection, and so forth, of zero-cross timing of the reproduction digital signals, and further, a phase error between the reproduction signal and the reproduction clock is detected from reproduction digital signal levels before and after the zero-cross timing. At this point in time, a phase comparison signal indicating execution of phase comparison is sent out to the digital phase error variation detection circuit 22, and a phase error level as detected is sent out to the digital phase system filter 14 and the digital frequency system filter 15.

A phase error control level, which is the output from the digital phase system filter 14, is fed to the subtraction circuit 16 while a frequency error control level, which is the output from the digital frequency system filter 15, is fed to the first addition circuit 17. The subtraction circuit 16 executes subtraction according to an instruction based on a correction signal from the digital phase error variation detection circuit 22, and generates a phase system control level to be thereby sent out to the second addition circuit 18. The first addition circuit 17 executes addition according to an instruction based a correction signal from the digital phase error variation detection circuit 22, and generates a frequency system control level to be thereby sent out to the second addition circuit 18. The second addition circuit 18 adds up the phase system control level from the subtraction circuit 16 and the frequency system control level from the first addition circuit 17 to thereby generate an oscillation control level, and the oscillation control level is converted into an analog voltage by the digital-to-analog conversion circuit 19, thereby deciding a frequency of the voltage controlled oscillator 20 (or reproduction clock generator).

Next, a configuration of the digital phase system filter 14 is specifically described by way of example. The phase error level received by the digital phase system filter 14 is sent to a coefficient unit provided inside the filter, and is multiplied by a coefficient of a predetermined gain before being fed to a digital LPF. The output of the digital LPF is sent out as the phase error control level. In this connection, the digital LPF comprises, for example, a transversal filter, and so forth, and generates the phase error control level by attenuating responses at high frequencies only before sending the same out. The digital LPF is not necessarily required, and the same is used if the PLL needs to suppress responses at high frequencies. Further, the coefficient unit is configured so as to enable coefficients to be changed over, setting such that a gain becomes smaller during, for example, data reproduction, in comparison with that during a synchronization pull-in pattern, based on a gain changeover signal as delivered.

Next, FIG. 3 shows a configuration of the digital frequency system filter 15 by way of example. In FIG. 3, reference numeral 25 denotes a coefficient unit, 26 an adder, and 27 a delay unit. The phase error level delivered to the digital frequency system filter 15 is delivered to the coefficient unit 25, and is multiplied by a coefficient of a predetermined gain before being delivered to the adder 26. The adder 26 adds up the output of the delay unit 27 and the output of the coefficient unit 25, and sends out the sum thereof. In this connection, the delay unit 27 is configured such that an input thereto is connected with the output of the adder 26, and the input is delayed by, for example, one cycle of the reproduction clock, and as a result, the digital frequency system filter 15 operates in such a way as to integrate the phase error levels on a reproduction clock unit basis. Further, the coefficient unit 25 is configured so as to enable the coefficients to be changed over, and is set such that a gain becomes smaller according to a gain changeover signal as delivered during, for example, data reproduction, in comparison with that during a synchronization pull-in pattern.

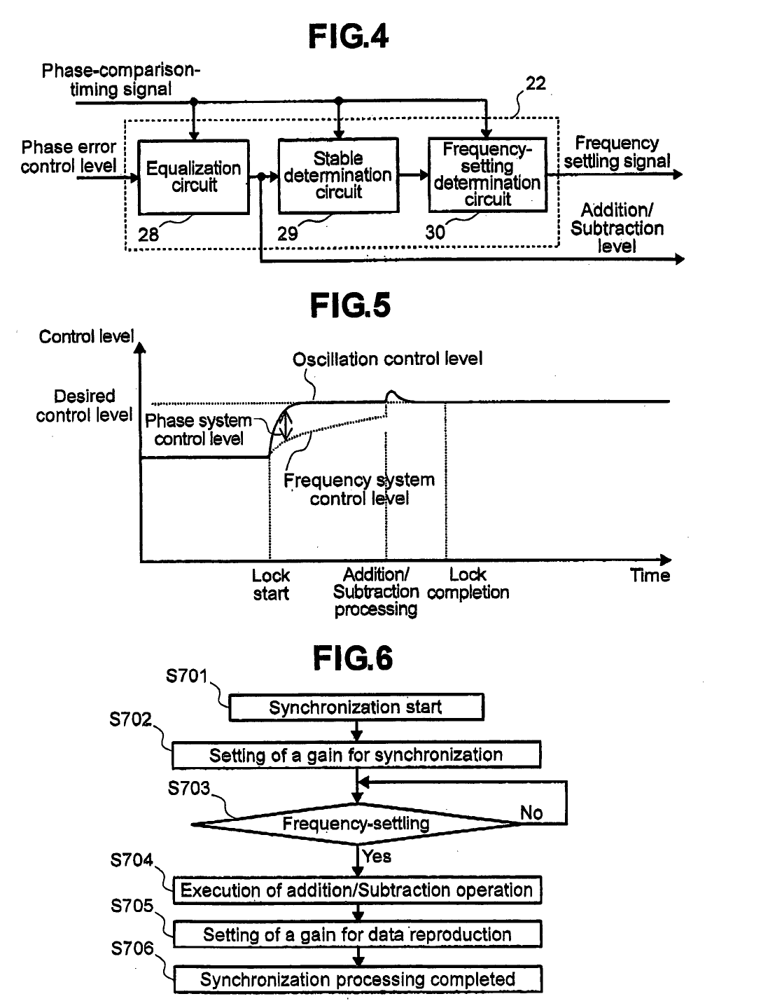

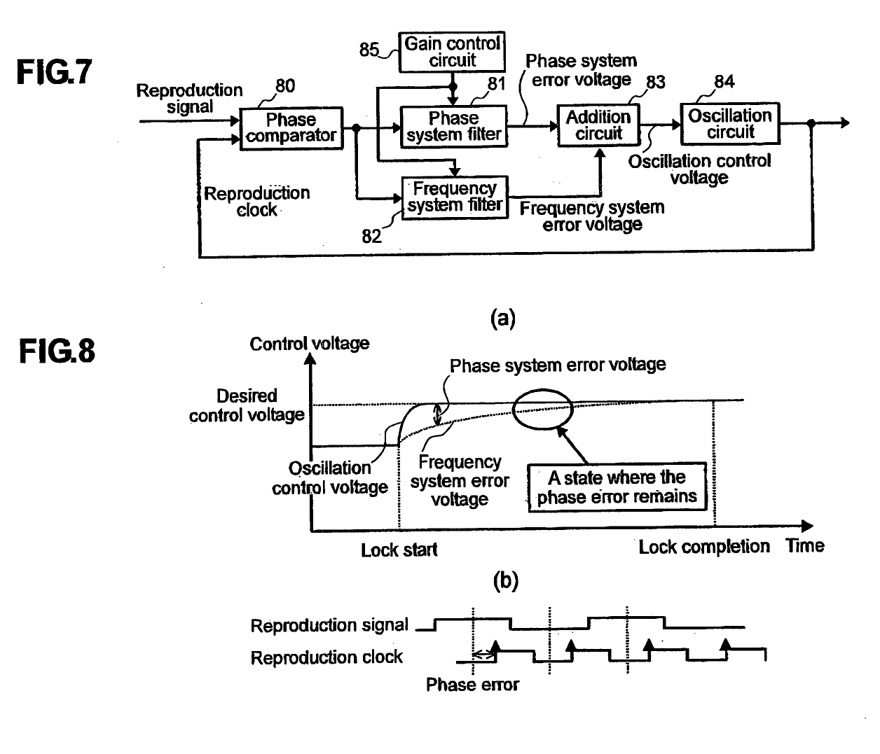

Further, FIG. 4 shows a configuration of the digital phase error variation detection circuit 22 by way of example. In FIG. 4, reference numeral 28 denotes an equalization circuit, 29 a stable determination circuit, and 30 a frequency settling determination circuit. The circuit 22 receives the phase comparison signal and phase error control signal from the digital phase comparator 13 and phase system filter 14, respectively. The respective circuits operate for every phase-comparison-timing signal (phase comparison signal), representing timing when the phase comparison is executed. As for the phase error control level asreceived, consecutive n1 pieces (n1 is a positive integer) of a mean value is calculated by the equalization circuit 28. Next, the calculated mean values are delivered to the stable determination circuit 29 to be compared with a predetermined value. If the mean values are not more than the predetermined value, a stable determination signal is sent out. The frequency settling determination circuit 30 sends out a frequency settling signal if the stable determination signals are consecutive in the phase comparison executed n2 (n2 is a positive integer) times. Further, at this point in time, the phase error control level as well is sent out. The digital phase error variation detection circuit 22 is configured so as to operate according to an instruction from the controller 8 or the reproduction signal processing circuit 7, shown in FIG. 1, and to operate only at a time of pull-in of the reproduction clock.

With the subtraction circuit 16 and the first addition circuit 17, in the PLL circuit, shown in FIG. 2, subtraction and addition by only an amount corresponding to a mean phase error control level is executed at timing when the frequency settling signal is sent out. FIG. 5 shows a state of transition of respective control levels over time. In the figure, a solid line indicates an oscillation control level, and a dotted line indicates a frequency system control level. Accordingly, a differential between the solid line and the dotted line represents the phase system control level. First, in the case where the reproduction clock has a frequency deviation at a point in time of a lock start, which is a pull-in start, the phase error due to the frequency deviation is first detected, whereupon the phase system control level undergoes a change. The oscillation control level is thereby controlled, causing an oscillation frequency to undergo a change, so that the frequency of the reproduction clock comes to be in sync with that of the reproduction signal.

Subsequently, as a result of integration of the phase errors, the frequency system control level undergoes gradual changes. At this point in time, the phase system control level decreases by an amount corresponding to a change in the frequency system control level such that the frequency of the reproduction clock does not come to be out of sync with that of the reproduction signal. That is, the reproduction signal and the reproduction clock come to be substantially at the same frequency, and subsequently, the phase error decreases, the transition proceeding in such a way as to lead to a synchronous phase relation as desired.

With the present embodiment, prior to full synchronization, a phase error variation amount is detected by the digital phase error variation detection circuit 22, whereupon frequency-settling determination is executed. In the case where it is determined that the phase error variation amount becomes less than a predetermined amount, and the frequency is stabilized, addition and subtraction operations are executed such that such a value causes the output of the subtraction circuit 16 to be substantially at zero is fed to the subtraction circuit 16 and the first addition circuit 17, so that the frequency system control level instantaneously converges to a desired value as shown in FIG. 5. Since, in this case, the phase is in deviated state although the frequency is in a locked state, the phase system control level undergoes a change for phase pull-in from this point onward, executing the phase pull-in by causing the oscillation control level to undergo variation.

FIG. 6 shows a flow of the operations as described above. First, synchronization start is executed by detection of the synchronization pull-in pattern, and so forth (step S701). Next, a gain for synchronization is set such that the PLL characteristics have a wider pull-in range (S702). Subsequently, frequency-settling determination is executed on the basis of the phase error variation amount (S703). If it is determined that the frequency is stabilized, addition and subtraction operations are executed against the phase system control level and the frequency system control level, respectively (S704). Thereafter, setting to a gain for data reproduction is set in order to cause the PLL characteristics resistant to noises, thereby completing synchronization (S705, S706). In the foregoing operation, by executing operation of the same value against the phase system control level, and the frequency system control level, at a time of frequency settling, variation of the oscillation control level, due to the operation, can be controlled, so that stable pull-in can be implemented.

Further, since an operation amount is the mean value of the phase system control levels, the frequency system control level can instantaneously transfers to a desired value to thereby undergo transition into a phase pull-in state, so that quick phase synchronization as compared the conventional case can be implemented.

Still further, in the frequency-settling determination, by further executing the determination continuously with the use of the equalization circuit, the effects of the noises can be eliminated even when the phase error undergoes variation because of many noises, thereby implementing stable control. Further, as a result of changing the PLL characteristics after the operation described as above, it becomes possible to implement combination of stable pull-in with the PLL characteristics optimum for data reproduction within a short period of time. Furthermore, since the PLL has the configuration of the digital circuit, the same has affinity for the digital signal processing such as the PRML method, and so forth, so that the record data can be restored with high precision, thereby providing an apparatus having achieved higher reliability.

The present invention has been described in terms of specific embodiments. These embodiments may be changed or modified without departing from the scope of the present invention. Accordingly, appended claims should be used to define the scope of the present invention.

1. An optical disk unit, comprising:
a pick-up component to read information stored on an optical disk provided within the disk unit and generate a reproduction signal corresponding to the information that has been read, the optical disk having a synchronization pull-in pattern region and a data region;
an equalization circuit to receive the reproduction signal from the pick-up component and output an equalized signal corresponding to the reproduction signal received from the pick-up component; and
a phase lock loop (PLL) circuit for generating a reproduction clock signal that is synchronized to the reproduction signal, the PLL circuit including: a reproduction clock generator to generate a first reproduction clock signal;
a phase comparator to detect a phase difference between the reproduction signal and the first reproduction clock signal and output a phase comparison signal and a phase error signal;
a phase detection circuit to receive the phase comparison signal and generate a correction signal for correcting the phase difference.

2. The optical disk unit of claim 1, wherein the PLL circuit further includes:
a phase system filter to receive the phase error signal from the phase comparator and output a phase error control signal;
a frequency system filter to receive the phase error signal from the phase comparator and output a frequency error control signal;
a subtraction circuit to receive the phase error control signal from the phase system filter and the correction signal from the phase detection circuit and output a phase system control signal, the phase system control signal being obtained as a result of performing a subtraction according to the correction signal;
a first addition circuit to receive a frequency error control signal from the frequency system filter and output a frequency system control signal, the frequency system control signal being obtained as a result of performing an addition according to the correction signal; and
a second addition circuit to receive the phase system control signal from the subtraction circuit and the frequency system control signal from the first addition circuit and output an oscillation control signal, the oscillation control signal being obtained as a result of adding the phase system control signal and the frequency system control signal.

3. The optical disk unit of claim 2, wherein the PLL circuit further, includes:
a digital-to-analog converter to receive the oscillation control signal from the second addition circuit and output an analog signal corresponding the oscillation control signal,
wherein the analog signal is provided to the reproduction clock generator for use in generating a second reproduction clock signal,
wherein the first and second reproduction clock signals are different clock cycles of reproduction clock signals generated by the reproduction clock generator.

4. The optical disk unit of claim 3, further comprising:
an analog-to-digital converter to receive the second reproduction signal from the reproduction clock generator and convert the second reproduction clock signal to a third reproduction clock signal that is in a digital format,
wherein the third reproduction clock signal is input to the phase comparator, so that the phase comparator may generate another phase error signal

5. A phase lock loop (PLL) circuit for generating a reproduction clock signal that is synchronized to the reproduction signal derived from a storage disk having a synchronization pull-in pattern region and a data region, the PLL circuit comprising:
a reproduction clock generator to generate a first reproduction clock signal;
a phase comparator to detect a phase difference between the reproduction signal and the first reproduction clock signal and output a phase comparison signal and a phase error signal;
a phase detection circuit to receive the phase comparison signal and generate a correction signal for correcting the phase difference;
a phase filter to receive the phase error signal and output a phase error control signal;
a frequency system filter to receive the phase error signal from the phase comparator and output a frequency error control signal; and
a subtraction circuit to receive the phase error control signal from the phase system filter and the correction signal from the phase detection circuit and output a phase system control signal, the phase system control signal being obtained as a result of performing a subtraction according to the correction signal.

6. The PLL circuit of claim 5, further comprising:
a first addition circuit to receive a frequency error control signal from the frequency system filter and output a frequency system control signal, the frequency system control signal being obtained as a result of performing an addition according to the correction signal; and
a second addition circuit to receive the phase system control signal from the subtraction circuit and the frequency system control signal from the first addition circuit and output an oscillation control signal, the oscillation control signal being obtained as a result of adding the phase system control signal and the frequency system control signal.

7. The PLL circuit of claim 6, wherein the reproduction clock generator generates the reproduction clock signal on the basis of input signals including a signal indicating the phase difference and the correction signal.

8. The PLL circuit according to claim 7, wherein the first reproduction clock signal is generated during reproduction of the synchronized pull-in pattern region on the disk.

9. The PLL circuit of claim 8, wherein the correction signal is equal in magnitude to the phase error signal.

10. An optical disk unit, comprising:
pick-up means for reading information stored on an optical disk provided within the disk unit and generating a reproduction signal corresponding to the information that has been read, the optical disk having a synchronization pull-in pattern region and a data region;
equalization means for receiving the reproduction signal from the pick-up means and outputting an equalized signal corresponding to the reproduction signal received from the pick-up means; and
means for generating a reproduction clock signal that is synchronized to the reproduction signal, wherein the means for generating the reproduction clock signal includes:
means for generating a first reproduction clock signal;
means for detecting a phase difference between the reproduction signal and the first reproduction clock signal;
means for outputting a phase comparison signal and a phase error signal;
means for receiving the phase comparison signal; and
means for generating a correction signal for correcting the phase difference.

11. The disk unit of claim 10, wherein the means for generating the reproduction clock signal further includes:
means for receiving the phase error signal from the phase comparator and 4 outputting a phase error control signal;
means for receiving the phase error signal from the phase comparator and outputting a frequency error control signal;
subtraction means for receiving the phase error control signal from the phase system filter and the correction signal from the phase detection circuit and outputting a phase system control signal, the phase system control signal being obtained as a result of performing a subtraction according to the correction signal;
first addition means for receiving a frequency error control signal from the frequency system filter and outputting a frequency system control signal, the frequency system control signal being obtained as a result of performing an addition according to the correction signal; and
second addition means for receiving the phase system control signal from the subtraction means and the frequency system control signal from the first addition means and output an oscillation control signal, the oscillation control signal being obtained as a result of adding the phase system control signal and the frequency system control signal.

12. A method for operating an optical disk unit, the method comprising:
reading information stored on an optical disk provided within the disk unit using a pick-up component, the optical disk having a synchronization pull-in pattern region and a data region;
generating a reproduction signal corresponding to the information that has been read by the pick-up component;
outputting an equalized signal corresponding to the reproduction signal received from the pick-up component; and
generating a reproduction clock signal that is synchronized to the reproduction signal using a phase lock loop (PLL) circuit,
wherein the PLL circuit generates a first reproduction clock signal, detects a phase difference between the reproduction signal and the first reproduction clock signal, outputs a phase comparison signal and a phase error signal, receives the phase comparison signal, and generates a correction signal for correcting the phase difference using the phase comparison signal.

13. A phase lock loop (PLL) circuit for generating a reproduction clock signal that is synchronized to a reproduction signal obtained by reading an optical disk, the PLL circuit comprising:
sampling means for sampling the reproduction signal obtained by reading the optical disk;
reproduction clock generation means for generating the reproduction clock;
phase comparison means for detecting a phase difference between respective sampled signals and the reproduction clock;
a frequency system filter for executing integration processing of an output of the phase comparison means with a predetermined multiple;
a phase system filter for amplifying the output of the phase comparison means by the predetermined multiple;
phase error variation detection means for detecting a phase error variation amount from the output of the phase comparison means;
first addition means for adding an amount received from the phase error variation detection means to an output of the frequency system filter;
subtraction means for subtracting the amount received from the phase error variation detection means from the output of the phase system filter;
wherein the reproduction clock generation means controls an oscillation frequency on the basis of the output of the digital-to-analog conversion means, and the phase error variation detection means sends an equal value to the first addition means and the subtraction means.

14. The PLL circuit according to claim 13, wherein the phase error variation detection means sends to the subtraction means a value that causes the output of the subtraction means to be substantially at zero.

15. The PLL circuit according to claim 13, wherein the phase comparison means sends a timing signal to the phase error variation detection means at phase comparison is executed, and while the phase error variation detection means calculates consecutive n1 pieces of moving averages of phase comparison results with a phase-comparison-timing signal from the phase comparison means as the timing signal, the phase error variation detection means are configured such that the timing signal for addition or subtraction is sent out to the first addition means and the subtraction means, respectively, when respective variation amounts of the moving averages are within a predetermined value consecutive n2 times, the n1 and n2 being positive integers.

16. The PLL circuit according to claim 13, wherein a gain of the frequency system filter and a gain of the phase system filter are changed after completion of addition to the first addition means and subtraction from the subtraction means.
